(19) United States
(12) Patent Application Publication
(10) Pub. No.: US 2024/0200728 A1
(43) Pub. Date: Jun. 20, 2024

(54) REMOTE TRIGGERING DEVICE FOR A PRESSURE VESSEL, AND ASSEMBLY WITH A COMPRESSED GAS RESERVOIR AND SUCH A REMOTE TRIGGERING DEVICE

(71) Applicant: Faurecia Hydrogen Solutions Germany GmbH, Augsburg (DE)

(72) Inventor: Richard TROTT, Augsburg (DE)

(21) Appl. No.: 18/538,461

(22) Filed: Dec. 13, 2023

(30) Foreign Application Priority Data
Dec. 14, 2022 (DE) 10 2022 133 278.0

(51) Int. Cl. F17C 13/04; F16K 31/02

(52) U.S. Cl. CPC F17C 13/04; F16K 31/025

(57) ABSTRACT

A remote triggering device comprises a housing, a piezoelectric element, a piston accommodated in the housing, and a prestressing device. The piston is adjustable between a starting position in which the prestressing device is held in a pretensioned state and an actuating position in which the piston is applied by the prestressing device against the piezoelectric element. The piston is held in the starting position by a temperature-sensitive locking mechanism. An assembly comprises a compressed gas reservoir, an electrically-actuated pressure relief valve that is attached to the compressed gas reservoir, and the remote triggering device.

### CROSS-REFERENCE TO RELATED APPLICATION

This application is a U.S. non-provisional application claiming the benefit of German Application No. 10 2022 133 278.0, filed on Dec. 14, 2022, which is incorporated herein by reference in its entirety.

### TECHNICAL FIELD

The disclosure relates to a remote triggering device for a pressure vessel and to an assembly with a compressed gas reservoir and a remote triggering device of this kind.

### BACKGROUND

In a vehicle, the compressed gas reservoir can be used to store a pressurized gas which is used to provide energy, in particular to drive the vehicle. The compressed gas can be hydrogen, for example.

The compressed gas reservoir is usually provided with a pressure relief valve which opens under predetermined ambient conditions in order to allow the content of the compressed gas reservoir to flow out of it in a controlled manner. Thermally activated pressure relief valves are known in this context which are activated when temperatures such as those occurring during an excessive temperature event are reached.

Various pressure relief valves are known from the prior art. In a simple embodiment, the pressure relief valve can be designed similarly to a fuse in which a closure element melts at high temperatures so that the compressed gas can flow out of the compressed gas container.

In more recent designs, electrically-actuated pressure relief valves have increasingly been used which have the advantage that they can be triggered by one or more remote triggering devices which can be arranged at different locations on the compressed gas reservoir or also at other positions in the vehicle. The operational safety is hereby increased insofar as the pressure relief valve opens not only when a temperature above a predetermined limit value prevails at it, but also when a limit temperature is exceeded at other points “monitored” by a remote triggering device.

### SUMMARY

A remote triggering device is provided that is distinguished by a simple design and a high functional reliability.

The remote triggering device comprises a housing, a piezoelectric element, a piston which is accommodated in the housing, and a prestressing device, wherein the piston is adjustable between an initial position in which the prestressing device is held in a prestressed state and an actuating position in which the piston is applied by the prestressing device against the piezoelectric element, wherein the piston is held in the starting position with a temperature-sensitive locking mechanism. The disclosure is based on the basic idea of using dimensional changes in the event of temperature changes to release the piston, so that, as soon as a structurally defined threshold is exceeded, the piston is applied against the piezoelectric element under the effect of the prestressing device, and generates there a voltage signal which is used to trigger the pressure relief valve.

According to one embodiment of the disclosure, the locking mechanism is formed by a press fit within the housing, wherein the press fit is dimensioned such that the holding force generated by it becomes smaller when a limit temperature is exceeded than the force generated by the prestressing device. This embodiment is based on the basic idea of using the thermal expansion of the housing and of the piston as a triggering mechanism or release mechanism. In the initial state, the piston is mechanically fixed in the housing so that the prestressing device cannot relax. If, due to thermal expansions, the clamping force that holds the piston in the starting position is no longer sufficient, it is released so that it strikes the piezoelectric element. A voltage is thereby generated which can either be used as a signal on the basis of which the pressure relief valve is opened, or the voltage pulse can be used directly to open the pressure relief valve. The particular advantage of the mechanical design is that no aging or settling processes influence the clamping force with which the piston is held in the starting position. Furthermore, an uncomplex design results.

According to one embodiment of the disclosure, it is provided that the coefficient of thermal expansion of the housing and of the piston differ from one another by less than 10%, in particular that the housing and the piston are made of the same material. This embodiment is based on the effect that, given a disc and a ring tightly enclosing it, the inner diameter of the ring increases more strongly under thermal expansions than the outer diameter of the disc. For example, steel can be used for the piston and the housing so that, despite an identical coefficient of thermal expansion, under increasing temperature, the press fit becomes firstly a transition fit and ultimately a clearance fit. If the speed at which the transition from a press fit to a clearance fit is to take place under rising temperatures is to be increased, materials having different coefficients of thermal expansion can also be used for the material of the housing and of the piston, wherein the coefficient of thermal expansion of the housing is greater than the coefficient of thermal expansion of the piston, in particular by more than 10%.

According to another example embodiment of the disclosure, it is provided that the receiving space has a clamping portion with a first diameter and a release portion with a second diameter which is greater than the first diameter, wherein the piezoelectric element is located on the side of the release portion, and the piston, in the starting position, is located in the clamping portion in the vicinity of the transition to the release portion. The advantage of this embodiment is that the piston, as soon as it has left its starting position, reliably strikes the piezoelectric element, even if the housing is at a lower temperature in regions which lie between the starting position of the piston and the piezoelectric element than where the piston is located in the starting position.

According to one embodiment, it is provided that the locking mechanism is formed by a press fit between the piston and a retaining element which is held in a recess in the piston by a press fit. This embodiment has the advantage that only the recess and the part of the retaining element received in the recess have to be machined precisely.

The locking mechanism can also be formed by a tensile element which acts between the housing and the piston, wherein the coefficient of thermal expansion of the housing is greater than the coefficient of thermal expansion of the tensile element. The advantage of this embodiment is that a form-fitting connection can be used in order to hold the piston in the starting position. Only when the difference between the thermal expansion of the housing and the thermal expansion of the tensile element is so great that the tensile element is destroyed is the piston released.

The tensile element can be a rod which is provided with a predetermined breaking point. This makes it possible to precisely adjust the breaking load at which the tensile element releases the piston.

The locking mechanism can also be formed by a retaining element which surrounds the piston and has a coefficient of thermal expansion which is smaller than the coefficient of thermal expansion of the piston, wherein the retaining element rests against a contact shoulder in the housing. A form fit is also used in this embodiment in order to reliably hold the piston in the starting position as long as the limit temperature has not yet been reached.

The retaining element can be designed as a closed ring which has a predetermined breaking point so that the breaking force can also be precisely set in this case.

In one example, the piezoelectric element is arranged on the side of the piston facing away from the prestressing element so that the piston directly strikes the piezoelectric element when the press fit is released enough so that the prestressing device moves the piston out of the starting position.

The piezoelectric element is, in one example, accommodated in the housing such that it is protected from external influences and the remote triggering device remains functional over operating times of several decades.

The housing can have a cylindrical receiving space in which the prestressing device and the piston are arranged. Such a cylindrical receiving space can be produced particularly easily, in particular if the cylindrical receiving space has a circular cross-section.

A heat-sensitive adhesive can be provided in the region between the piston and the housing and can be used to increase the clamping effect of the press fit.

The prestressing device can in principle be any mechanism which is suitable for applying the piston, as soon as it is released, under a sufficiently high force to the piezoelectric element so that it generates the desired voltage pulse. A magnetic prestress, a pressure gas cushion, or the like is conceivable. A mechanical compression spring made of spring steel is particularly preferred since it provides a substantially unchanged high prestress force over a very long period of time.

An assembly is also provided that comprises a compressed gas reservoir, an electrically-actuated pressure relief valve which is attached to the compressed gas reservoir, and a remote triggering device, as explained above. A particular advantage of this assembly is that the remote triggering device can be attached at a distance from the pressure relief valve at such locations, either on the compressed gas reservoir or, for example, in a vehicle, which are suitable for detecting high temperatures which are critical for safe operation of the pressurized gas reservoir. Another particular advantage compared to the triggering of a conventional thermally activated pressure relief device which is in direct contact with the pressure vessel via a compressed gas line, is that an electrical line is insensitive with respect to unintentional release of the gaseous fuel under direct effects of external mechanical loads which can occur, for example, in the event of a vehicle impact.

### BRIEF DESCRIPTION OF THE DRAWINGS

The disclosure is described below with reference to an embodiment which is shown in the accompanying drawings. In the figures:

FIG. 1 schematically shows an assembly with a compressed gas reservoir, a pressure relief valve, and three remote triggering devices;

FIG. 2 shows a schematic section of one of the remote triggering devices used in the assembly of FIG. 1 according to a first embodiment;

FIG. 3 shows a schematic section of a remote triggering device according to a second embodiment;

FIG. 4 shows a schematic section of a remote triggering device according to a third embodiment;

FIG. 5 shows the remote triggering device of FIG. 5 in the triggered state;

FIG. 6 shows a schematic section of a remote triggering device according to a fourth embodiment;

FIG. 7 in a plan view shows the holding element used in the remote triggering device of FIG. 6,

FIG. 8 shows a schematic section of the remote triggering device of FIG. 6 in the triggered state; and

FIG. 9 in a plan view shows the retaining element of the remote triggering device of FIG. 8.

### DETAILED DESCRIPTION

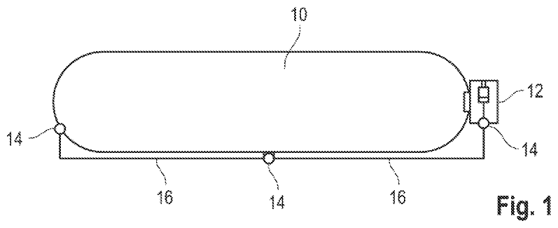

FIG. 1 shows a compressed gas reservoir 10 which is provided to store a gas that is under a high pressure. The gas can be used to provide drive energy for a motor vehicle, for example in order to directly operate an internal combustion engine or also a fuel cell with which electrical energy is generated. The gas stored in the compressed gas reservoir 10 can be hydrogen, for example.

The gas stored in the compressed gas reservoir can be under a pressure of several hundred bar. In order to reliably prevent the compressed gas reservoir 10 from being damaged in a high temperature event, a pressure relief valve 12 is attached to the compressed gas reservoir 10. When ambient temperatures are above a predetermined limit value, the valve opens a pressure relief opening through which the compressed gas contained in the pressure accumulator 10 can flow out in a controlled manner. The compressed gas reservoir 10 is then pressureless, so that it remains inconsequential if its structure should be weakened or fundamentally damaged at further rising temperatures.

The pressure relief valve 12 is in particular an electrically triggered pressure relief valve. Various designs are known for this. One example is a pyrotechnic charge which is electrically ignited if necessary. The compressed gas generated after the ignition of the pyrotechnic charge then opens the pressure relief opening, for example by destroying a membrane or moving a valve element from a closed position into an open position.

A plurality of remote triggering devices 14, which are connected to the pressure relief valve 12 via a line 16, are arranged on the compressed gas reservoir 10.

The remote triggering devices 14 can generally be regarded as sensors which are arranged at suitable locations on the compressed gas reservoir 10 in order to monitor whether inadmissibly high temperatures are present, i.e., temperatures above a predetermined limit value. The limit value is selected in particular such that it lies below the temperatures at which a structural weakening or damage to the pressurized gas reservoir 10 occurs.

In the shown exemplary embodiment, one remote triggering device 14 is arranged at each of the two ends of the pressurized gas reservoir 10 and approximately centrally between the ends on the outer circumference.

Further remote triggering devices can also be provided separately from the compressed gas reservoir 10 beyond the shown remote triggering devices 14.

The line 16 is in particular an electrical cable that is designed with such a strength that it is not damaged by the loads occurring in the event of a vehicle accident.

If a temperature which is greater than a predetermined limit value prevails at one of the remote triggering devices 14, an electrical signal is transmitted via the line 16 and causes the pressure relief valve 12 to be activated, i.e., opened. As a result, the gas contained in the compressed gas reservoir 10 is released to the surroundings in a controlled manner.

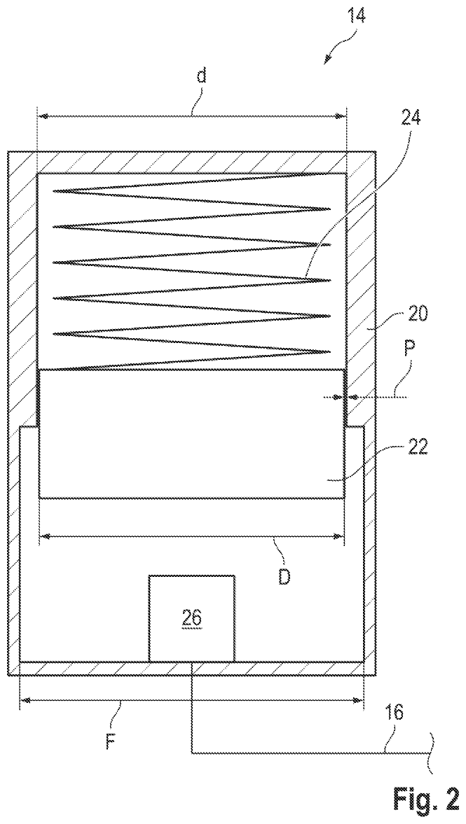

In FIG. 2, one of the remote triggering devices 14 is shown in section.

The remote triggering device 14 has a housing 20, which here has an elongated, cylindrical interior. The housing 20 has in particular a circular cross-section.

A piston 22 is arranged in the interior of the housing 20 and divides the interior of the housing 20 into two portions. A prestressing device 24 is arranged on one side of the piston 22 (above in the shown exemplary embodiment). A piezoelectric element 26 is arranged on the opposite side.

In the shown exemplary embodiment, the prestressing device 24 is a compression spring made of spring steel.

FIG. 2 shows the piston 22 in a starting position in which it is fixed within the housing 20 with a temperature-sensitive locking mechanism.

In the shown embodiment, the temperature-sensitive locking mechanism is formed by a press fit. The press fit is symbolized here by the reference sign P. The press fit is produced by the fact that, at normal operating temperatures of the assembly formed from the compressed gas reservoir 10 and the remote triggering device 14, i.e., in the range of, for example, −40 to +80 degrees Celsius, the outer diameter D of the piston 22 is so much greater than the inner diameter d of the housing 20 that the piston 22 is elastically clamped within the housing 20. The clamping forces or retaining forces generated here are greater than the force that is exerted by the prestressing device 24 on the side of the piston 22 remote from the piezoelectric element 26 and biases the piston 22 toward the piezoelectric element 26.

Steel in particular is suitable as the material for the housing 20 and the piston 22.

If the temperature in the surroundings of the remote triggering device 14 increases, the inner diameter d of the housing 20 increases by thermal expansion. At the same time, the outer diameter D of the piston 22 increases. Under the assumption that the coefficient of thermal expansion of the material of the housing is similar to the coefficient of thermal expansion of the material of the piston 22, however, the inner diameter D of the housing 20 increases more than the outer diameter D of the piston 22. As a result, the holding forces which are provided by the press fit P are reduced with increasing temperature until the forces generated by the prestressing device 24 are ultimately greater than the retaining forces which hold the piston 22 in the starting position of FIG. 2. From this moment, the piston 22 is acted upon by the prestressing device 24 against the piezoelectric element 26.

From the impact of the piston 22 on the piezoelectric element 26, an electrical voltage is generated in the latter and is conducted via the line 16 to the pressure relief valve 12.

As can be seen in FIG. 2, the inner diameter of the housing 20 is not constant over the entire axial length of the interior. On the side of the piston 22 facing away from the prestressing device 24, the inner diameter (here denoted by the reference sign F) is greater than in the region in which the piston 22 is clamped in the starting position. This ensures that, as soon as it is released, the piston 22 cannot continue to be braked by friction effects on its way toward the piezoelectric element 26, but strikes the piezoelectric element 26 unhindered under the effect of the prestressing device 24. Corresponding to the different diameters, the receiving space in the interior of the housing 20 is referred to in the region with the diameter d as a clamping portion, while it is regarded as a release portion in the region with the inner diameter F.

The selected oversize of the piston 22 relative to the inner diameter d of the clamping portion of the housing 20 is selected such that the clamping force of the press fit P up to the desired limit temperature is greater than the force of the prestressing device 24.

The release of the piston 22 can also be influenced by using different materials for the housing 20 and the piston 22, namely a material for the housing 20 which has a significantly greater coefficient of thermal expansion than the material of the piston 22. As a result, the inner diameter d of the housing 20 increases when there is a temperature rise at a greater rate than the outer diameter D of the piston 22.

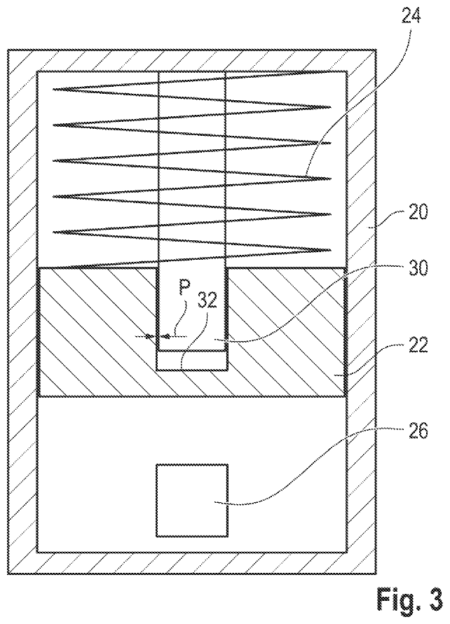

FIG. 3 shows a second embodiment. The same reference signs are used for the components and features known from the first embodiment, and in this respect, reference is made to the above explanations.

In the second embodiment too, the temperature-sensitive locking mechanism is formed by a press fit. In contrast to the embodiment of the remote triggering device of FIG. 2, the press fit in this case is formed between the piston 22 and a holding element 30 which is fixedly attached to the housing 20.

The holding element 30 is designed in this case as a rod which is held in a receptacle 32 in the piston 22 with a press fit so that the holding force is greater than the effect of the prestressing device 24.

The piston 22 itself is accommodated with play in the interior of the housing 20.

In principle, the same material can be used for the holding element 30 and the piston 22, since the dimensions of the recesses increase to a greater extent in the event of a temperature increase than the diameter of the retaining element 30. Nevertheless, a material of which the coefficient of expansion is higher than the coefficient of expansion of the retaining element 30 can be used for the piston 22.

If a structurally defined limit temperature is exceeded, the press fit develops into a transition fit so that the piston 22 is released and is applied against the piezoelectric element 26 under the effect of the prestressing device 24.

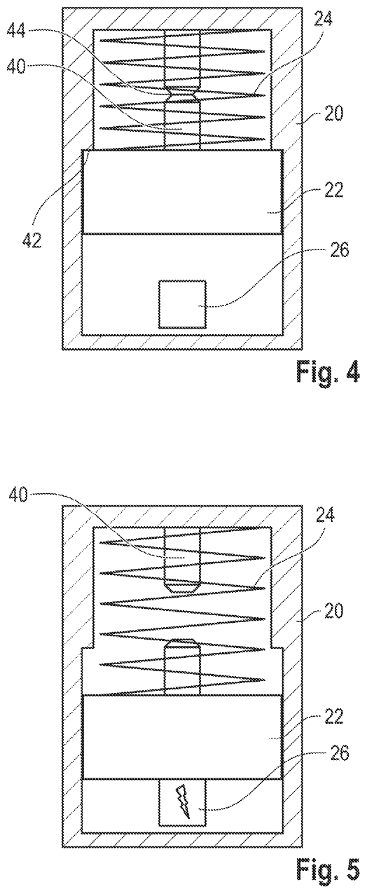

FIG. 4 shows a third embodiment of the remote triggering device. The same reference signs are used for the component parts and features known from the preceding embodiments, and in this respect reference is made to the above explanations.

In the third embodiment, the temperature-sensitive locking mechanism is formed by a tensile element 40, the one end of which is fixedly attached to the housing 20, and the other end of which is fixedly attached to the piston 22. The piston 22 in turn rests against a shoulder 42 in the housing.

The tensile element 40 is designed here as a rod having a predetermined breaking point 44.

The material of the housing 20 is selected relative to the material of the tensile element 40 such that the coefficient of thermal expansion of the housing 20 is higher than the coefficient of thermal expansion of the tensile element 40. Therefore, when the remote triggering device is heated, the distance between the shoulder 42 and the upper portion of the housing 20, to which the tensile element 40 is attached, increases more than the length of the tensile element 40 increases.

In the initial state, the piston 22 rests against the shoulder 42 with no or at most very slight play. When the remote triggering device 14 is heated, the end at which the tensile element 40 is attached moves away from the piston 22 so that increasingly stronger tensile forces are exerted on the tensile element 40. At a certain point, the predetermined breaking point 44 yields so that the prestressing device 24 can press the piston 22 against the piezoelectric element 26 (see FIG. 5).

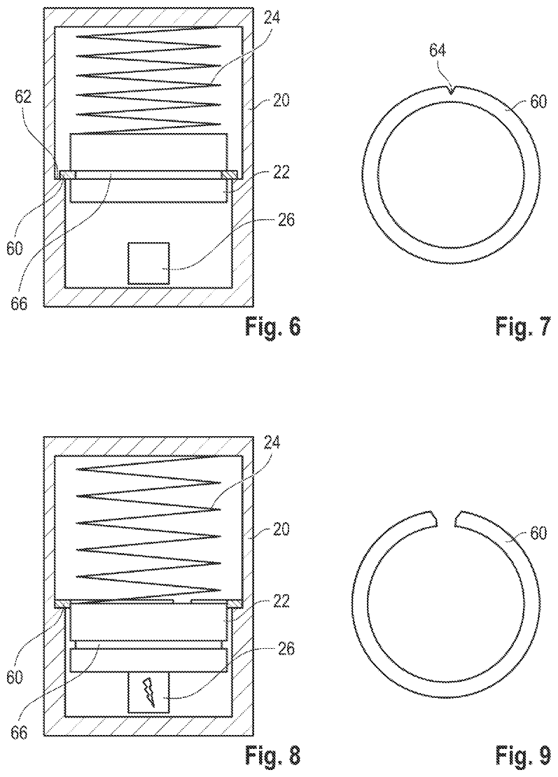

FIG. 6 shows a fourth embodiment. The same reference signs are used for the component parts and features known from the preceding embodiments, and in this respect reference is made to the above explanations.

In the fourth embodiment, the temperature-sensitive locking mechanism is formed by a retaining element 60 which rests against a contact shoulder 62 in the housing 20.

The retaining element 60 is formed by a ring closed in the circumferential direction (see FIG. 7), which is provided with a predetermined breaking point 64.

In the shown exemplary embodiment, the holding element 60 is accommodated in a circumferential groove 66 of the piston 22. For this purpose, the piston can be designed in two parts in order to enable the mounting of the retaining element 60. It is also possible for the piston 22 to be stepped, wherein the diameter in the lower portion of the piston 22 in FIG. 6 then corresponds to the inner diameter of the retaining element 60.

In this embodiment, for the piston 22, a material is used of which the coefficient of thermal expansion is higher than the coefficient of thermal expansion of the material of which the retaining element 60 consists.

In the initial state, the retaining element 60 supports the piston 22 against the effect of the prestressing device 24. When the remote triggering device 14 is heated, the piston 22 expands to such an extent that the holding element 60 is destroyed (see FIG. 9) so that it can no longer hold the piston 22 in the starting position. This is then applied under the effect of the prestressing device 24 against the piezoelectric element 26 (see FIG. 8).

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A remote triggering device comprising:
a housing; a piezoelectric element; a piston which is accommodated in the housing; and
a prestressing device, wherein the piston is adjustable between a starting position in which the prestressing device is held in a pretensioned state and an actuating position in which the piston is applied by the prestressing device against the piezoelectric element, and wherein the piston is held in the starting position by a temperature-sensitive locking mechanism.

2. The remote triggering device according to claim 1, wherein the temperature-sensitive locking mechanism is formed by a press fit within the housing, wherein the press fit is dimensioned such that a holding force generated by the press fit becomes smaller, when a limit temperature is exceeded, than a force generated by the prestressing device.

3. The remote triggering device according to claim 2, wherein a coefficient of thermal expansion of the housing and of the piston differ from one another by less than 10%.

4. The remote triggering device according to claim 2, wherein a coefficient of thermal expansion of the housing is greater than a coefficient of thermal expansion of the piston.

5. The remote triggering device according to claim 2, wherein a receiving space has a clamping portion with a first diameter and a release portion with a second diameter which is greater than the first diameter, and wherein the piezoelectric element is located on a side of the release portion, and the piston is located, in the starting position, in the clamping portion in a vicinity of a transition to the release portion.

6. The remote triggering device according to claim 1, wherein the temperature-sensitive locking mechanism is formed by a press fit between the piston and a holding element which is held in a recess in the piston with the press fit.

7. The remote triggering device according to claim 1, wherein the temperature-sensitive locking mechanism is formed by a tensile element that acts between the housing and the piston, and wherein a coefficient of thermal expansion of the housing is greater than a coefficient of thermal expansion of the tensile element.

8. The remote triggering device according to claim 7, wherein the tensile element is a rod having a predetermined breaking point.

9. The remote triggering device according to claim 1, wherein the temperature-sensitive locking mechanism is formed by a holding element which surrounds the piston and has a coefficient of thermal expansion which is smaller than a coefficient of thermal expansion of the piston, and wherein the holding element rests against a contact shoulder in the housing.

10. The remote triggering device according to claim 9, wherein the holding element is a closed ring which has a predetermined breaking point.

11. The remote triggering device according to claim 1, wherein the piezoelectric element is arranged on a side of the piston facing away from the prestressing device.

12. The remote triggering device according to claim 1, wherein the piezoelectric element is accommodated in the housing.

13. The remote triggering device according to claim 1, wherein the housing has a cylindrical receiving space in which the prestressing device and the piston are arranged.

14. The remote triggering device according to claim 13, wherein the cylindrical receiving space has a circular cross-section.

15. The remote triggering device according to claim 1, wherein a heat-sensitive adhesive is provided in a region between the piston and the housing.

16. An assembly comprising:
a compressed gas reservoir;
an electrically-actuated pressure relief valve which is attached to the compressed gas reservoir; and
a remote triggering device according to claim 1.

17. The remote triggering device according to claim 3, wherein the housing and the piston are made of the same material.

18. The remote triggering device according to claim 4, wherein the coefficient of thermal expansion of the housing is greater than the coefficient of thermal expansion of the piston, by more than 10%.
